(19) United States
(12) Patent Application Publication
(10) Pub. No.: US 2005/0132569 A1
(43) Pub. Date: Jun. 23, 2005

(54) Method of repairing a part using laser cladding

(76) Inventors: Donald G. Clark, Iuka, MS (US); Randall A. Iverson, Washington, IL (US)

Correspondence Address: CATERPILLAR INC.;100 N.E. ADAMS STREET, PATENT DEPT., PEORIA, IL, 616296490, US

(21) Appl. No.: 10/744,209

(22) Filed: Dec. 22, 2003

(51) Int. Cl. B23P 6/00; B23P 19/04

(52) U.S. Cl. 29/888.041; 29/402.09; 29/402.16

(57) ABSTRACT

The present invention provides for a method of repairing a part, having a damaged portion that has deviated from an original configuration, by using a laser cladding process. The process comprises the steps of applying cladding material to the damaged portion, and irradiating the cladding material with the laser beam until such time as the cladding material substantially bonds with the part thereby forming a repaired area having a configuration substantially the same as the original configuration.

### TECHNICAL FIELD

The present invention is directed to a method of repairing a part and, more particularly, a method of repairing piston ring grooves using a laser cladding operation.

### BACKGROUND

Typically, an internal combustion engine commonly includes a crankshaft and a plurality of cylinders sized to receive a respective piston. A connecting rod couples each piston to the crankshaft. Each cylinder includes a combustion chamber that contains the high pressure gases formed during the combustion process of the fuel within the combustion chamber. To ensure that the combustion process occurs in an efficient manner, it is important that the interface of the piston and combustion chamber be sealed. This is typically accomplished by the use of one or more piston rings that are placed within piston ring grooves provided on the piston crown. Over time, the piston ring grooves will wear to a point that they are outside of design specifications. This wear can result in the loss of sealing of the combustion chamber thereby decreasing the efficiency of the combustion process.

Those engine components that sustain damage or wear are oftentimes recycled or, as it is typically referred to, “remanufactured”. This assumes the component is not beyond repair and a suitable method to repair the component exists. Traditionally, repairing of the piston ring grooves was accomplished by machining the worn grooves so that they became larger than what the original specification called for. These “oversized” piston ring grooves then required “oversized” piston rings which may result in requiring different rings for the same piston. The use of different rings for the same piston could subsequently result in a mis-matching of the rings with the ring grooves during assembly and/or installing the wrong ring or rings.

The present invention is intended to overcome one or more of the problems set forth above.

### SUMMARY OF THE INVENTION

In accordance with an embodiment of the present invention, a method of repairing a part, having a damaged portion that has deviated from an original configuration, by using a laser cladding process is provided. The process comprises the steps of applying cladding material to the damaged portion, and irradiating the cladding material with the laser beam until such time as the cladding material substantially bonds with the part thereby forming a repaired area having a configuration substantially the same as the original configuration.

### BRIEF DESCRIPTION OF THE DRAWINGS

FIG. 1 is a partial sectional view of a piston crown;

FIG. 2 is a blown up view of that portion of that portion of the piston crown of FIG. 1 comprising the ring grooves;

FIG. 3 is a sectional view of ring grooves exhibiting wear characteristics;

FIG. 4 is a diagrammatical view of a piston crown shown being repaired in accordance with the method of the present invention;

FIG. 5 is a block diagram depicting a method of the present invention; and

FIG. 6 is a sectional view of ring grooves which have been repaired in accordance with the teachings of the present invention.

### DETAILED DESCRIPTION

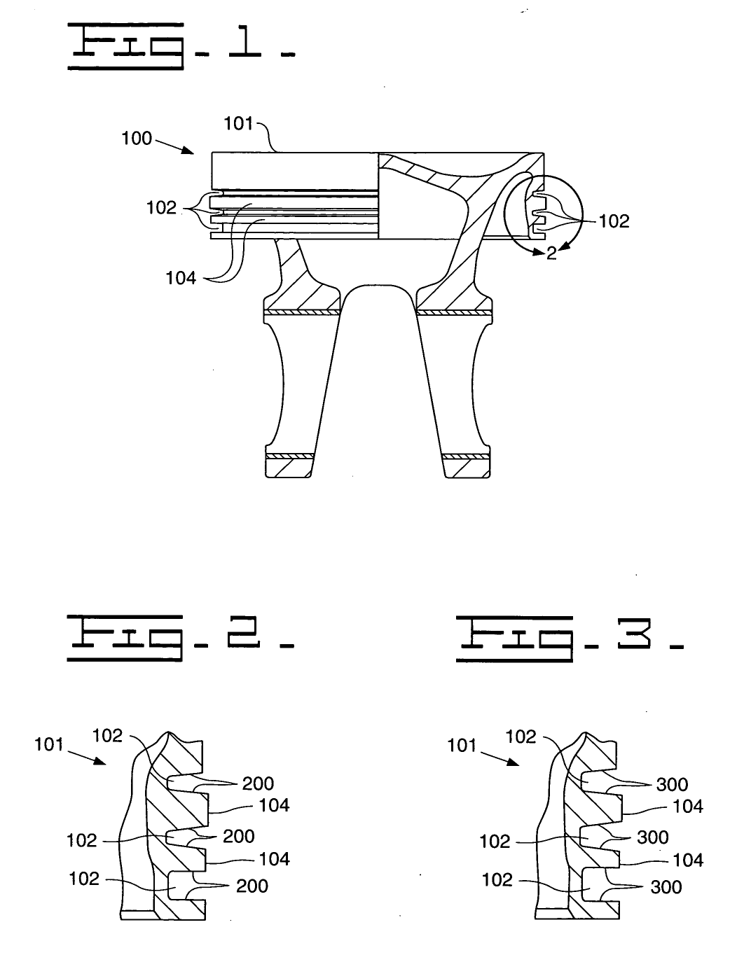

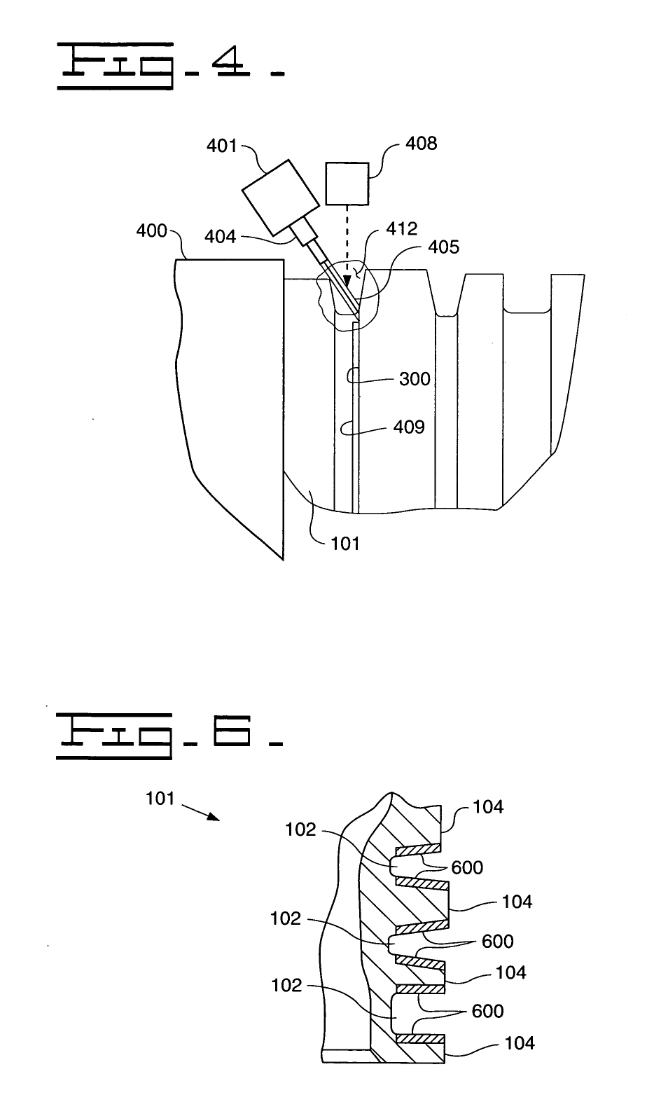

With reference now to the figures FIGS. 1-3, shown is a part such as the exemplary piston 100, which includes a piston crown 101, of the type used with internal combustion engines (not shown). Formed on the piston crown 101 and extending circumferentially thereabout are a plurality of ring grooves each denoted as 102. Each ring groove 102 is sized to receive a piston ring (not shown) and each is separated from each other by a respective land 104. With reference to FIG. 2, each piston ring groove 102 is bounded by an upper and lower face all designated herein as 200. In FIG. 2, each ring groove 102 is shown in its substantially normal condition. In other words, the location of each face 200 is substantially where it would be if manufactured in accordance with the original specifications. In comparison to FIG. 2, shown in FIG. 3 is a portion of the piston crown 101 in which the faces, each denoted as 300, have experienced wear of a sufficient degree as to cause the faces 300 to recede from their original FIG. 2 position.

With reference now to FIG. 4, shown is a representative piston crown 101 in the process of being repaired in accordance with the teachings of the present invention. The piston crown 101 is shown coupled to a machine capable of rotating the piston crown 101 such as the laser cladding machine 400 shown. The laser cladding machine 400 may include a welding device 401 of the type utilizing a laser 404 such as, for example, a CO2 laser, that is placed adjacent to the piston crown 101 in such a manner as to allow the laser 404 to focus its beam 405 on that portion of the face 300 that is in need of repair. An example of a suitable laser clad machine is the Huffman HC-205 Five Axis Laser Powder Fusion Welder commercially available from Huffman Corporation (Clover, S.C.). A source of cladding material, denoted 408, is provided to supply the material used to build-up those areas of the faces 300 that have receded. For those piston crowns 101 that are manufactured from steel, the cladding material may comprise an alloy steel powder or other suitable material. In addition, for the exemplary welding device 401 depicted herein, the welding device 401 is configured to feed the material directly into the beam 405 of the laser 404 thereby creating a bead 409 on face 300. To prevent contamination of the bead 409, a shielding gas 412 such as Argon is supplied to the area being clad.

### Industrial Applicability

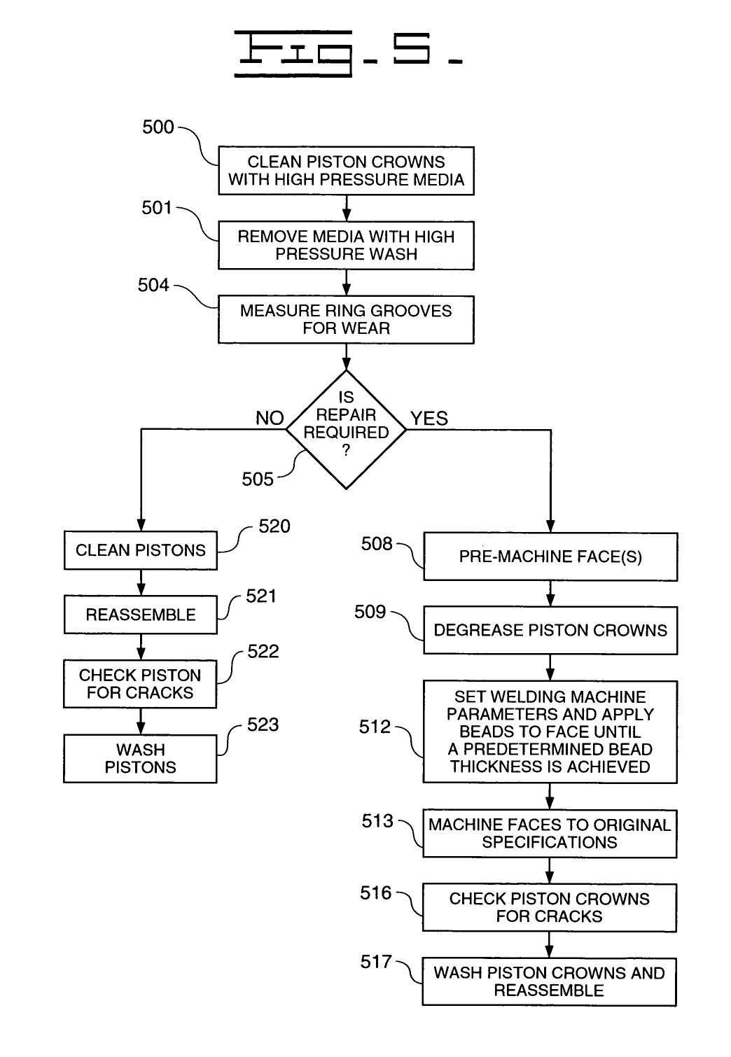

With reference to the FIG. 5 flowchart, block 500 depicts the initial step in the repairing of the piston crowns 101. Each piston crown 101 is cleaned with a high pressure apparatus such as a blaster which uses ceramic beads or a baking soda/aluminum oxide mixture as the blasting medium. Next, the process moves to block 501 where the piston crown 101 is processed through a high pressure washer to remove any excess media remaining. After the initial cleaning process, the ring grooves 102 are measured to determine the need for repair, as depicted in block 504.

If it is determined that repair is needed (as depicted by decision block 505), the process then moves to block 508 where the faces 300 that are in need of repair are pre-machined, by using the above-identified laser cladding machine 400 or other like machine, a pre-determined amount, such as 0.020 inch, so as to provide for a uniform geometry of the face 300. Prior to the laser cladding operation, the process proceeds to block 509 in which the piston crowns 101 are degreased to remove any remaining oil or contaminants.

Once the pre-machining and cleaning is complete, the process proceeds to block 512 where the piston crown 101 is attached to the laser cladding machine 400 and the laser 404 is oriented to direct its beam 405 onto the face 300 in need of repair. For the exemplary process described herein, the diameter of the beam 405 is selected to be approximately 0.040 inches at a power level of approximately 1350 watts which has been found to be an acceptable power level in this application to provide sufficient fusion between the cladding material 408 and face 300. The cladding material 408 is then fed into the beam 405 at a rate of approximately 3.45 grams per minute and the cladding material 408 and the face 300 are irradiated by the beam 405 for a length of time required to cause the cladding material 408 an the face 300 to bond together. Depending on the diameter of the piston crown 101 being repaired, the speed of the piston crown 101 in the laser cladding machine 400 should be selected to provide a cladding bead 409 of approximately 0.040 inches on the face 300. During the cladding process, the shielding gas 412 such as Argon is supplied to the area being clad at a rate of approximately 1 cubic foot per minute. Additional beads 409 are then applied in such a manner as to be stacked on the preceding bead until the face 300 extends past the original specification location. In other words, the distance between the two faces 300 of a ring groove 102 are less than they were when the ring groove 102 was originally formed in accordance with the original specifications (e.g., the width of the ring groove 102 is less than the original width of the ring groove 102). When the face 300 has been built-up to a pre-determined amount, an additional pass with the laser 404 may be used to temper the repaired face 300. An additional pass with the laser 404 to temper the heat effected area of the piston crow 101 may be performed at this time, either with or without cladding material 408, using a predetermined wattage to achieve a proper temper.

Once the laser cladding process is complete, the process proceeds to block 513 where the faces 300 that were repaired are again machined using the laser cladding machine 400 or other like machine to original print specifications. After this machining step, the process proceeds to block 516 where the piston crowns 101 are tested for any cracks using any suitable method such as, for example, magnetic particle testing. Finally, as shown in block 517, the piston crowns 101 are again washed and any needed assembly, such as installing pin bushings (not shown), is completed. Shown in FIG. 6 is a portion of the piston crown 101 showing the repaired areas of the ring grooves 102 comprising the new faces 600 formed in accordance with the teachings of the present invention.

If it is determined that repair is not needed (as depicted by decision block 505), the process then moves to blocks 520-523 where the pistons 100 are, respectfully, cleaned, reassembled by installing new pin bore bushings (not shown), tested for cracks again using a suitable process such as a magnetic particle testing method, and finished washed.

Other aspects, objects and advantages of this invention can be obtained from a study of the drawings, the disclosure and the appended claims.

1. A method of repairing ring grooves of a piston that have deviated from an original ring groove width, comprising the steps of:
applying cladding material to the area of the ring groove in need of repair; and
irradiating said cladding material with a laser beam until such time as the cladding material substantially bonds with the piston crown thereby forming a repaired area.

2. The method as set forth in claim one including the step of continuing to add cladding material to the area of the ring groove in need of repair until the ring groove has a width that is less than the original ring groove width.

3. The method as set forth in claim 1 including the step of using said laser beam to temper the repaired area.

4. The method as set forth in claim 3 including the step machining the repaired ring groove until the ring groove has a width that is substantially the same as an original ring groove width.

5. The method as set forth in claim 4 including the step of testing said repaired area for defects.

6. The method of claim 5 wherein said testing step is performed by a magnetic particle test.

7. The method as set forth in claim 5 including the step of washing said piston crown.

8. The method as set forth in claim 1 wherein said step of applying cladding material to the area of the ring groove in need of repair is by feeding said cladding material into the laser beam.

9. A piston produced in accordance with the method of claim 1.

10. A method of repairing a part using a laser cladding process, the part having a damaged portion that has deviated from an original configuration, comprising the steps of:
applying cladding material to the damaged portion; and
irradiating said cladding material with said laser beam until such time as the cladding material substantially bonds with the part thereby forming a repaired area having a configuration substantially the same as the original configuration.

11. The method as set forth in claim 10 wherein said step of applying cladding material to the damaged portion is by feeding said cladding material into the laser beam.

12. The method as set forth in claim 10 including the step of using said laser beam to temper the repaired area.

13. A part produced in accordance with the method of claim 10.
